(19) United States
(12) Patent Application Publication
(10) Pub. No.: US 2019/0098151 A1
(43) Pub. Date: Mar. 28, 2019

(54) INFORMATION PROCESSING APPARATUS, FREQUENCY CHANGE METHOD, AND NON-TEMPORARY RECORDING MEDIUM

(71) Applicants: KABUSHIKI KAISHA TOSHIBA, Tokyo (JP); TOSHIBA TEC KABUSHIKI KAISHA, Tokyo (JP)

(72) Inventor: Makoto Matsui, Mishima Shizuoka (JP)

(21) Appl. No.: 15/713,819

(22) Filed: Sep. 25, 2017

(51) Int. Cl. H04N 1/00; G06F 3/046; G06F 3/044

(52) U.S. Cl. CPC H04N 1/00411; G06F 3/044; G06F 3/046

(57) ABSTRACT

An information processing apparatus comprises a touch panel and a frequency change control section. The touch panel is an electrostatic capacity type touch panel. The frequency change control section changes a scan frequency of the touch panel.

### FIELD

Embodiments described herein relate generally to an information processing apparatus, a frequency change method, and a non-temporary recording medium.

### BACKGROUND

Conventionally, as an information processing apparatus for receiving an operation from a user by an electrostatic capacity type touch panel, for example, an image forming apparatus such as a multi-functional peripheral is known.

There is a case in which a malfunction is caused by interference in the electrostatic capacity type touch panel if a frequency of a radio wave generated by an external device and a scan frequency of the touch panel are overlapped. As a result, the image forming apparatus including the touch panel may not be able to normally receive the operation from the user. The radio wave is generated from, for example, another device (for example, a lighting device such as a fluorescent lamp and the like) arranged at the periphery.

### BRIEF DESCRIPTION OF THE DRAWINGS

FIG. 1 is an external view illustrating an example of an entire constitution of an image forming apparatus 100 according to an embodiment;

FIG. 2 is a diagram illustrating an example of functional components of the image forming apparatus 100;

FIG. 3 is a diagram illustrating an example of functional components of a first control section 300;

FIG. 4 is a diagram illustrating an example of a flow of a processing carried out by the first control section 300; and

FIG. 5 is a diagram illustrating an example of a flow of a processing carried out by a second control section 121.

### DETAILED DESCRIPTION

In accordance with an embodiment, an information processing apparatus comprises a touch panel and a frequency change control section. The touch panel is an electrostatic capacity type touch panel. The frequency change control section changes a scan frequency of the touch panel.

Hereinafter, as an example of an information processing apparatus, an image forming apparatus of an embodiment is described with reference to the accompanying drawings. In each figure, the same reference numeral is applied to the same element. Hereinafter, as an example of the image forming apparatus, an image forming apparatus 100 is exemplified.

(Details of the Image Forming Apparatus)

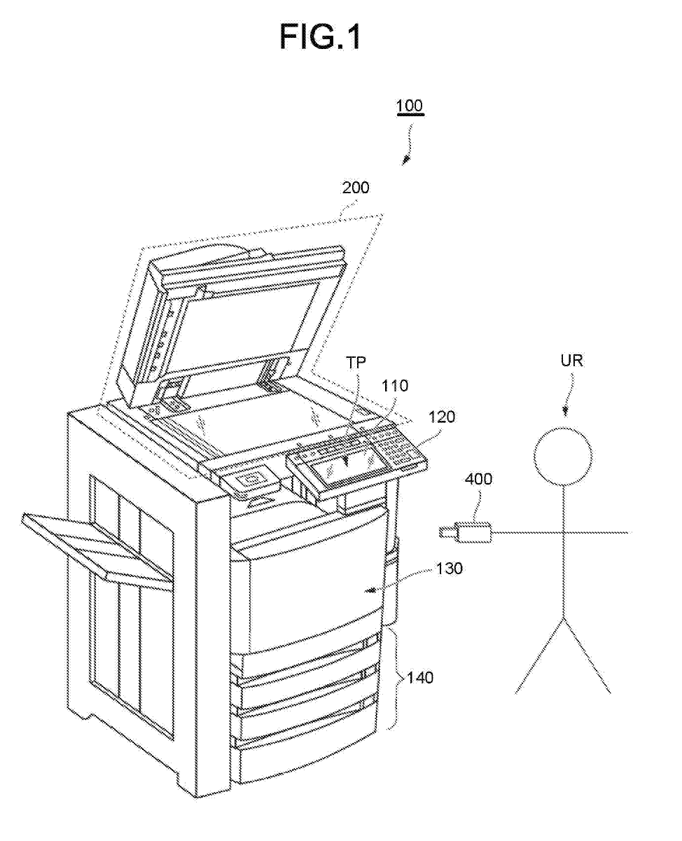

Hereinafter, details of the image forming apparatus 100 are described with reference to FIG. 1.

FIG. 1 is an external view illustrating an example of an entire constitution of the image forming apparatus 100 according to the embodiment. The image forming apparatus 100 is, for example, a multi-functional peripheral. The image forming apparatus 100 includes a display 110, a control panel 120, a printer section 130, a sheet housing section 140, an image reading section 200 and a connection section (not shown). Furthermore, the printer section 130 of the image forming apparatus 100 may be an electrophotographic type device for fixing a toner image or an inkjet type device.

The image forming apparatus 100 forms an image on a sheet with a developing agent such as toner. The sheet is, for example, a paper. Furthermore, the sheet maybe an optional sheet as long as the image forming apparatus 100 can form an image on the surface of the sheet, such as a label paper.

The display 110 is an image information processing device such as a liquid crystal display, an organic EL (Electro Luminescence) display and the like. The display 110 displays various kinds of information relating to the image forming apparatus 100.

The control panel 120 receives an operation of a user. At least apart of the control panel 120 is integrally constituted with the display 110 as a touch panel TP. Further, the control panel 120 may include one or more buttons. The control panel 120 outputs a signal corresponding to an operation carried out by the user to a control section of the image forming apparatus 100. Furthermore, the control panel 120 may be separated from the display 110. The touch panel TP is an electrostatic capacity type touch panel. The touch panel TP operates according to a scan frequency set in the control panel 120 by the image forming apparatus 100.

The printer section 130 forms an image on a sheet on the basis of image information generated by the image reading section 200 or image information received via a communication path. The printer section 130 forms the image through, for example, the following processing. The image forming section of the printer section 130 forms an electrostatic latent image on a photoconductive drum on the basis of the image information. The image forming section of the printer section 130 enables a developing agent to adhere to the electrostatic latent image to form a visible image. As a concrete example of the developing agent, toner is exemplified. The transfer section of the printer section 130 transfers the visible image on the sheet. The fixing section of the printer section 130 heats and pressures the sheet to enable the visible image to be fixed on the sheet. Furthermore, the sheet on which the image is formed may be a sheet housed in the sheet housing section 140 or a manually fed sheet.

The sheet housing section 140 houses a sheet used for image formation by the printer section 130.

The image reading section 200 reads the image information of a read object as intensity of light. The image reading section 200 records the read image information. The recorded image information may be sent to another information processing apparatus via a network. The recorded image information may be used for the image formation on the sheet by the printer section 130.

The connection section is a connector with which an external storage section 400 is connected. For example, the connection section is arranged on the control panel 120. Furthermore, the connection section may be arranged at a position different from the control panel 120 in the image forming apparatus 100.

The external storage section 400 is an auxiliary storage device externally connected with the image forming apparatus 100. For example, the external storage section 400 is a USB (Universal Serial Bus) memory. Furthermore, the external storage section 400 may be another externally connectable auxiliary storage device such as an externally connected hard disk instead of the USB memory. In the example shown in FIG. 1, the external storage section 400 is not connected to the connection section. In this example, the external storage section 400 is owned by a user UR. The user UR can connect the external storage section 400 to the connection section as needed. The user UR is, for example, a manager who manages the image forming apparatus 100. Furthermore, the user UR may be another user who utilizes the image forming apparatus 100 instead of the manager.

(Functional Components of the Image Forming Apparatus)

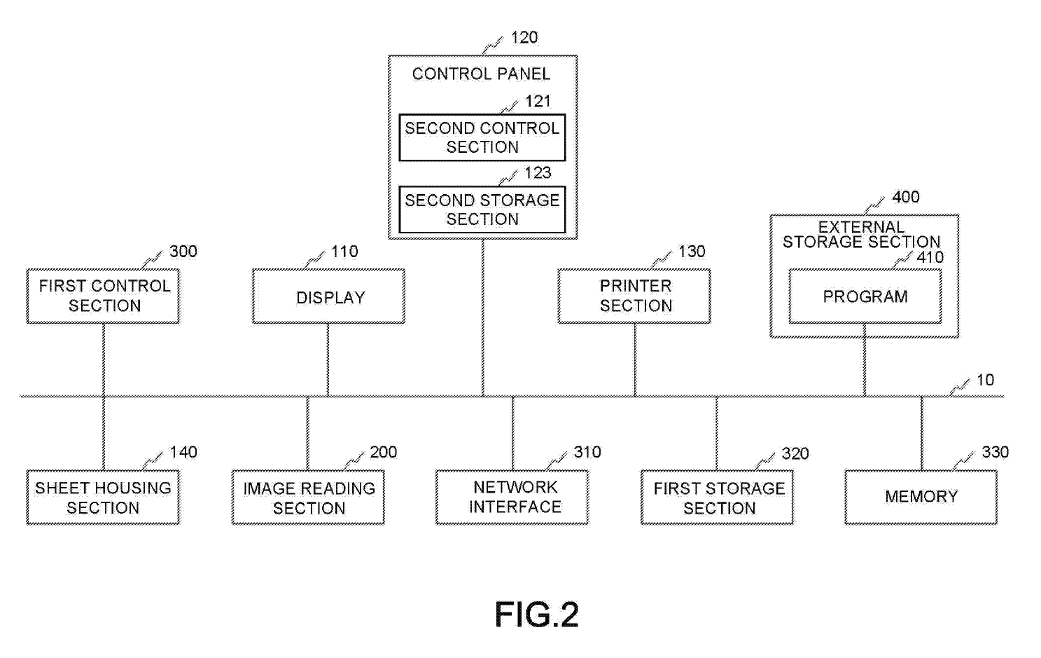

Hereinafter, the functional components of the image forming apparatus 100 are described with reference to FIG. 2.

FIG. 2 is a diagram illustrating an example of the functional components of the image forming apparatus 100. Further, FIG. 2 is a diagram illustrating an example of the functional components of the image forming apparatus 100 in a state where the external storage section 400 is connected.

The image forming apparatus 100 includes a first control section 300, the display 110 and the control panel 120. The image forming apparatus 100 further includes the printer section 130, the sheet housing section 140 and the image reading section 200. The image forming apparatus 100 further includes a network interface 310, a first storage section 320, a memory 330 and the external storage section 400. These respective functional sections included by the image forming apparatus 100 are connected in a communicable manner via a system bus 10.

The descriptions of the display 110 and the printer section 130 are the same as those described above, and thus are omitted. Further, the descriptions of the sheet housing section 140 and the image reading section 200 are the same as those described above, and thus are omitted. Hereinafter, the first control section 300, the control panel 120, the network interface 310, the first storage section 320, the memory 330 and the external storage section 400 are described.

The first control section 300 includes a CPU (Central Processing Unit) of the image forming apparatus 100. The first control section 300 controls operations of respective functional sections of the image forming apparatus 100. The first control section 300 executes various processing by executing a program. The first control section 300 acquires, from the control panel 120, an instruction input by the user. In other words, the first control section 300 receives the operation from the user by the control panel 120. The first control section 300 executes a control processing on the basis of the acquired instruction.

The control panel 120 includes a second control section 121 and a second storage section 123.

The second control section 121 includes a CPU of the control panel 120. The second control section 121 controls operations of respective functional sections of the control panel 120. The second control section 121 executes various processing by executing a program. Software of the control panel 120 is included in the program. The second control section 121 acquires, from the first control section 300, a request from the first control section 300. The second control section 121 executes a control processing on the basis of the acquired request. The second control section 121 is an example of a control section for controlling the touch panel.

The second storage section 123 is, for example, an auxiliary storage device such as a hard disk, an SSD (Solid State Drive) and the like. The second storage section 123 stores various data.

The network interface 310 carries out transmission and reception of data with another device. The network interface 310 operates as an input interface and receives data transmitted from another device. Further, the network interface 310 operates as an output interface, and transmits data to another device.

The first storage section 320 is, for example, an auxiliary storage device such as a hard disk, an SSD (Solid State Drive) and the like. The first storage section 320 stores various data.

The memory 330 is, for example, a RAM (Random Access Memory). The memory 330 temporarily stores data used by each functional section included by the image forming apparatus 100. Furthermore, the memory 330 may store data generated by the image reading section 200, a program for operating respective functional sections, and the like.

As described above, the external storage section 400 is an auxiliary storage device externally connected with the image forming apparatus 100. A program 410 is stored in advance in the external storage section 400.

The program 410 enables the image forming apparatus 100 to start a processing for changing a scan frequency of the control panel 120.

(Functional Components of the Control Section Included By the Image Forming Apparatus)

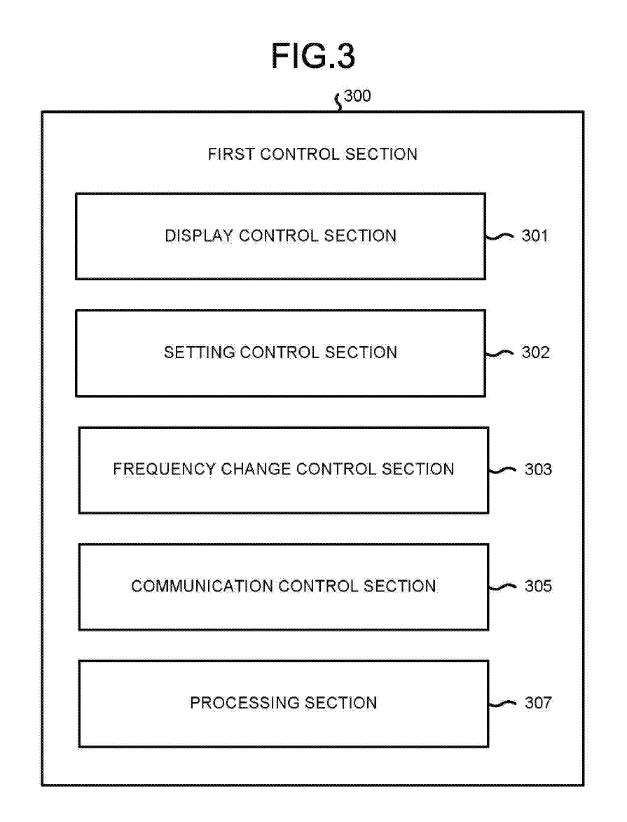

Hereinafter, the functional components of the first control section 300 are described with reference to FIG. 3. FIG. 3 is a diagram illustrating an example of the functional components of the first control section 300.

The first control section 300 includes a display control section 301, a setting control section 302, a frequency change control section 303, a communication control section 305 and a processing section 307. Furthermore, part or all of these functional sections may be hardware functional sections such as an LSI (Large Scale Integration), an ASIC (Application Specific Integrated Circuit) and the like.

The display control section 301 generates various images depending on the operation received from the user. The display control section 301 displays the generated images on the display 110.

The setting control section 302 enables the second control section 121 to carry out an initial setting processing. The initial setting processing sets a setting value of 1 or more set in the control panel 120 to a setting value stored in advance in the second storage section 124. A scan frequency of the touch panel TP is at least included in the setting value of 1 or more set in the control panel 120. Furthermore, for example, a luminance value of a back light in the display constituted integrally with the control panel 120, a value relating to a key scan of the control panel 120 and the like may be included in the setting value of 1 or more.

The frequency change control section 303 specifies a frequency based on a predetermined rule in a case in which a predetermined condition is met. The frequency change control section 303 sets the specified frequency in the control panel 120 as a scan frequency of the touch panel TP. Specifically, the setting control section 302 sets the frequency in the control panel 120 as the scan frequency by enabling the second storage section 123 to store frequency information as scan frequency information. The frequency information is information indicating the frequency. The scan frequency information is information indicating the scan frequency.

The communication control section 305 carries out communication with another device via the network interface 310.

The processing section 307 carries out a processing corresponding to an operation received from the user by the image forming apparatus 100.

(Processing Carried Out By the First Control Section)

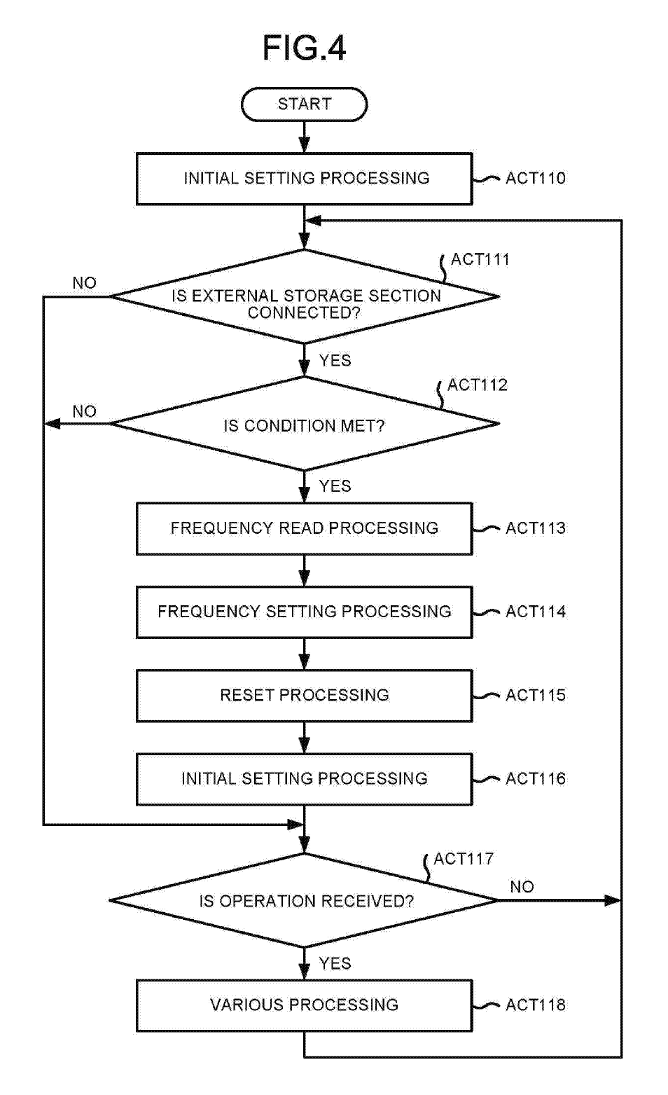

Hereinafter, the flow of the processing carried out by the first control section 300 is described with reference to FIG. 4. FIG. 4 is a diagram illustrating an example of the flow of the processing carried out by the first control section 300. Herein, the processing of the flowchart shown in FIG. 4 is an example of a processing started in a case in which a power supply of the image forming apparatus 100 is turned on by the user UR.

The setting control section 302 enables the second control section 121 to carry out the initial setting processing (ACT 110).

Next, the frequency change control section 303 determines whether or not the external storage section 400 is connected with the connection section described above (ACT 111).

If the frequency change control section 303 determines that the external storage section 400 is not connected with the connection section (No in ACT 111), the processing section 307 determines whether to receive an operation (ACT 117). The operation is an operation received from the user by the control panel 120. If the processing section 307 determines that the operation is not received (No in ACT 117), the frequency change control section 303 transits to the processing in ACT 111, and re-determines whether or not the external storage section 400 is connected with the connection section. On the other hand, if it is determined that the operation is received (Yes in ACT 117), the processing section 307 carries out various processing corresponding to the operation (ACT 118). Then, the frequency change control section 303 transits to the processing in the ACT 111, and re-determines whether or not the external storage section 400 is connected with the connection section.

On the other hand, if it is determined that the external storage section 400 is connected with the connection section (Yes in ACT 111), the frequency change control section 303 determines whether or not the predetermined condition described above is met (ACT 112). The predetermined condition is a condition under which the program 410 is stored in the external storage section 400 in this example. Furthermore, the predetermined condition may be another condition instead of this condition.

If the frequency change control section 303 determines that the predetermined condition is not met (No in ACT 112), the processing section 307 transits to the processing in ACT 117. Then, in ACT 117, the processing section 307 determines whether to receive the operation from the user via the control panel 120.

On the other hand, if it is determined that the predetermined condition is met (Yes in ACT 112), the frequency change control section 303 carries out a frequency read processing (ACT 113). For example, the frequency change control section 303 carries out the following processing as the frequency read processing. The frequency change control section 303 sends, to the second control section 121, a frequency information acquisition request serving as a request of scan frequency information acquisition stored in the second storage section 123. The frequency information acquisition request is, for example, a command for enabling the second control section 121 to read out the scan frequency information from the second storage section 123 and sending the read scan frequency information to the frequency change control section 303. Herein, the scan frequency information is, for example, numbers respectively indicating a plurality of predetermined frequencies different from each other which are frequencies settable in the control panel 120 as scan frequencies. Furthermore, the scan frequency information may be respective values of the frequencies, or other information respectively indicating the frequencies instead of the numbers.

Hereinafter, a case in which the frequencies are five frequencies of X001 hertz, X002 hertz, X003 hertz, X004 hertz and X005 hertz is described as an example. The magnitude relation between the frequencies is X001 hertz<X002 hertz<X003 hertz<X004 hertz<X005 hertz. Further, hereinafter, a casein which the scan frequency information indicating the X001 hertz is 1 is described as an example. Hereinafter, a case in which the scan frequency information indicating the X002 hertz is 2 is described as an example. Hereinafter, a case in which the scan frequency information indicating the X003 hertz is 3 is described as an example. Hereinafter, a case in which the scan frequency information indicating the X004 hertz is 4 is described as an example. Further, hereinafter, a case in which the scan frequency information indicating the X005 hertz is 5 is described as an example.

After sending the frequency information acquisition request to the second control section 121, the frequency change control section 303 waits for until the scan frequency information is acquired from the second control section 121 as a response to the frequency information acquisition request. The frequency change control section 303 transits to a processing in ACT 114 if acquiring the scan frequency information from the second control section 121. The frequency change control section 303 carries out such a processing as the frequency read processing in ACT 113.

After acquiring the scan frequency information from the second control section 121 in ACT 113, the frequency change control section 303 carries out a frequency setting processing (ACT 114). For example, the frequency change control section 303 carries out the following processing as the frequency setting processing. The frequency change control section 303 specifies the frequency based on the predetermined rule described above. The frequency based on the predetermined rule is, for example, a frequency indicated by a number obtained by adding +1 to the scan frequency information acquired in the processing in ACT 113. For example, if the scan frequency information acquired in the processing in ACT 113 is 2, the frequency change control section 303 specifies the frequency indicated by 3 as the frequency based on the predetermined rule. The frequency indicated by 3 is X003 hertz in this example. Furthermore, the frequency based on the predetermined rule is a frequency indicated by the minimum value in a case in which the number is greater than the maximum value. The maximum value is the maximum number of numbers respectively indicating five predetermined frequencies different from each other which are frequencies settable in the control panel 120 as scan frequencies. In other words, the maximum value is 5 in this example. The minimum value is the minimum number of the numbers respectively indicating the five predetermined frequencies different from each other which are the frequencies settable as the scan frequencies in the control panel 120. In other words, the minimum value is 1. Furthermore, the frequency based on the predetermined rule may be, for example, a frequency indicated by a number obtained by adding −1 to the scan frequency information acquired in the processing in ACT 113 instead of this frequency. In this case, the frequency based on the predetermined rule is the frequency indicated by the maximum value in a case in which the number is smaller than the minimum value. Further, the frequency based on the predetermined rule may be another frequency based on the scan frequency information which is a frequency different from the scan frequency information acquired in the processing in ACT 113. The frequency change control section 303 sends, to the second control section 121, a frequency setting request serving as a request for enabling the second control section 121 to store the frequency information indicating the specified frequency in this way into the second storage section 123 as the scan frequency information. The frequency setting request is, for example, a command for enabling the second control section 121 to store the frequency information into the second storage section 123 as the scan frequency information. Further, the frequency setting request is a command indicating the frequency information. In this way, the frequency change control section 303 can set the frequency indicated by the frequency information in the control panel 120 as the scan frequency. The frequency change control section 303 carries out such a processing as the frequency setting processing in ACT 114.

Next, the setting control section 302 enables the second control section 121 to carry out a reset processing for clearing (deleting) the setting value of 1 or more set in the control panel 120 (ACT 115). The reset processing is a preprocessing carried out on the control panel 120 before the initial setting processing is carried out. For example, the reset processing restarts the hardware included by the control panel 120.

Next, the setting control section 302 enables the second control section 121 to carry out the initial setting processing described above (ACT 116). By carrying out the initial setting processing after executing the reset processing, the scan frequency of the touch panel TP is set to the frequency indicated by the scan frequency information stored in the second storage section 123.

Next, the processing section 307 transits to the processing in ACT 117, and determines whether to receive the operation from the user via the control panel 120.

In this way, the image forming apparatus 100 specifies the frequency based on the predetermined rule if the predetermined condition is met. Then, the image forming apparatus 100 sets the specified frequency in the control panel 120 as the scan frequency of the touch panel TP. In this way, the image forming apparatus 100 can suppress that a malfunction is caused in the touch panel TP due to a radio wave irradiated from an external device.

Furthermore, the first control section 300 and the second control section 121 may be constituted as one control section.

Further, the frequency change control section 303 may be a functional section constituted in such a manner that the CPU of the first control section 300 reads the program 410 from the external storage section 400 and executes it. In this case, at a timing prior to the execution of the processing in ACT 113 which is a timing after the execution of the processing in ACT 112, the CPU executes the program 410 and constitutes the frequency change control section 303.

Further, the predetermined condition is a condition under which a frequency change button is pressed which is a hardware button arranged in the image forming apparatus 100. In this case, the image forming apparatus 100 can change the scan frequency of the control panel 120 even if the external storage section 400 is not connected. In other words, the image forming apparatus 100 changes the scan frequency set in the control panel 120 depending on a predetermined operation serving as the received operation (for example, an operation for pressing the frequency change button). In this way, the image forming apparatus 100 can more easily suppress that the malfunction is caused in the touch panel TP due to the radio wave irradiated from the external device. Further, in this case, the image forming apparatus 100 periodically changes the scan frequency to the frequency indicated by each of a plurality of frequency information different from each other stored in advance in the second storage section 123 each time the operation is carried out. In this way, the image forming apparatus 100 can more certainly suppress that the malfunction is caused in the touch panel TP due to the radio wave irradiated from the external device. Furthermore, the frequency change button may be arranged in a device for carrying out communication with the image forming apparatus 100 in a wireless or wired manner which is a device different from the external storage section 400. On the other hand in discussion, the device may be detachable with the image forming apparatus 100. The device is an example of another device connected with the information processing apparatus.

Further, as shown in FIG. 4, the image forming apparatus 100 repeatedly carries out the processing in ACT 112-ACT 117 each time the external storage section 400 is connected. In other words, the external storage section 400 periodically changes the scan frequency to the frequency indicated by each of the plurality of frequency information different from each other stored in advance in the second storage section 123 each time the external storage section 400 is connected. In this way, the image forming apparatus 100 can more certainly suppress that the malfunction is caused in the touch panel TP due to the radio wave irradiated from the external device.

Further, the first storage section 320 and the second storage section 123 may be constituted integrally.

(Processing Carried Out By the Second Control Section)

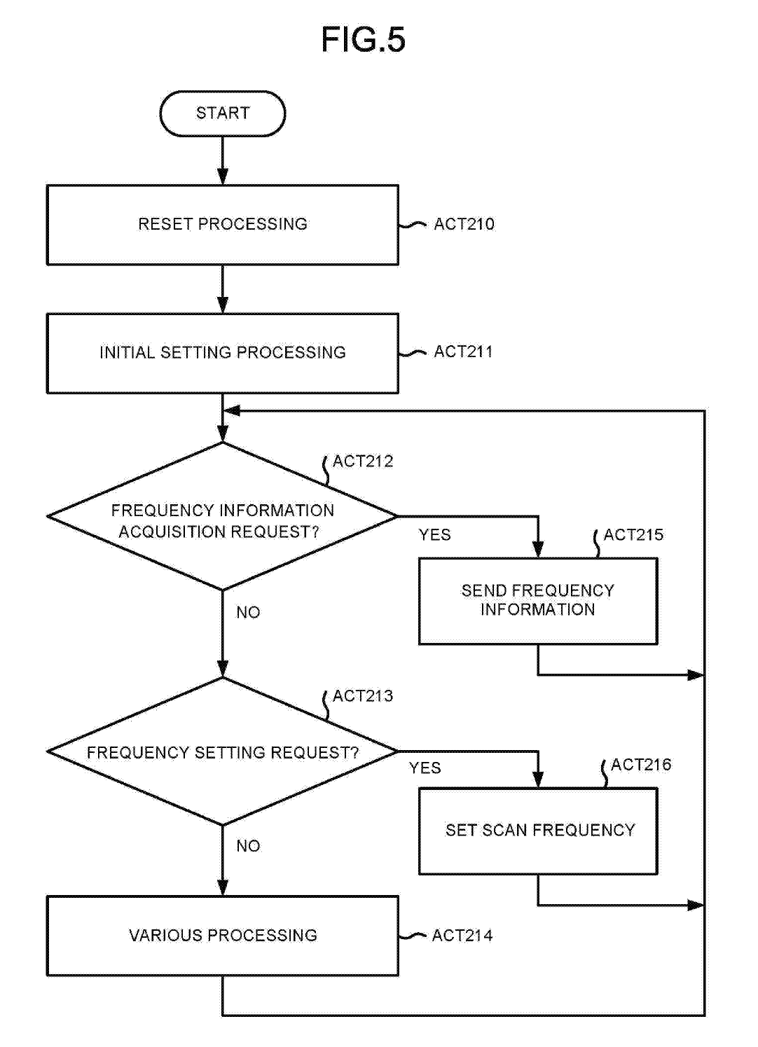

Hereinafter, the flow of the processing carried out by the second control section 121 is described with reference to FIG. 5. FIG. 5 is a diagram illustrating an example of the flow of the processing carried out by the second control section 121. Herein, the processing of the flowchart shown in FIG. 5 is an example of a processing started in a case in which the power supply of the image forming apparatus 100 is turned on by the user UR.

The second control section 121 carries out the reset processing described above (ACT 210).

Next, the second control section 121 carries out the initial setting processing described above (ACT 211).

Next, the second control section 121 determines whether to receive the frequency information acquisition request from the first control section 300 (ACT 212). If it is determined that the frequency information acquisition request is received from the first control section 300 (Yes in ACT 212), the second control section 121 reads out, from the second storage section 123, the scan frequency information stored in the second storage section 123. Then, the second control section 121 sends the read scan frequency information to the first control section 300 as a response to the frequency information acquisition request (ACT 215). The second control section 121 transits to the processing in ACT 212 after sending the response, and re-determines whether to receive the frequency information acquisition request from the first control section 300. On the other hand, if it is determined that the frequency information acquisition request is not received from the first control section 300 (No in ACT 212), the second control section 121 determines whether to receive the frequency setting request from the first control section 300 (ACT 213).

If it is determined that the frequency setting request is received from the first control section 300 (Yes in ACT 213), the second control section 121 transits to a processing in ACT 216. In ACT 216, the second control section 121 enables the second storage section 123 to store the frequency information indicated by the frequency setting request received in the processing in ACT 213 as the scan frequency information. In this way, the second control section 121 sets the frequency indicated by the frequency information in the control panel 120 as the scan frequency (ACT 216). The second control section 121 transits to the processing in ACT 212 after setting the scan frequency in the control panel 120, and re-determines whether to receive the frequency information acquisition request from the first control section 300.

On the other hand, if it is determined that the frequency setting request is not received from first control section 300 (No in ACT 213), the second control section 121 executes various processing (ACT 214). The various processing is, for example, a processing corresponding to the operation received from the user via the control panel 120, a processing corresponding to the request from the first control section 300 and the like. After the processing in ACT 214 is carried out, the second control section 121 transits to the processing in ACT 212, and re-determines whether to receive the frequency information acquisition request from the first control section 300.

In this way, the control panel 120 changes the scan frequency set in the control panel 120 depending on the request from the first control section 300. In this way, the image forming apparatus 100 can suppress that the malfunction is caused in the touch panel TP due to the radio wave irradiated from the external device.

Furthermore, the processing for changing the scan frequency described above may be a constitution applied to another information processing apparatus including an electrostatic capacity type touch panel instead of the image forming apparatus 100. For example, the processing may be a constitution applied to a POS (Point Of Sales) system including the touch panel instead of the image forming apparatus 100. The processing may be a constitution applied to a multifunctional mobile phone terminal (smart phone) including the touch panel instead of the image forming apparatus 100. The processing may be a constitution applied to a tablet PC (Personal Computer) including the touch panel. The processing may be a constitution applied to a notebook PC including the touch panel. The processing may be a constitution applied to an E-book reader including the touch panel. Further, the processing may be a constitution applied to a PDA (Personal Digital Assistant) including the touch panel.

As described above, the information processing apparatus described as the image forming apparatus 100 in the above changes the scan frequency of the electrostatic capacity type touch panel (in this example, the touch panel TP). In this way, the information processing apparatus can suppress that the malfunction is caused in the touch panel due to the radio wave irradiated from the external device.

Further, the information processing apparatus changes the scan frequency to any of frequencies respectively indicated by a plurality of frequency information different from each other stored in a storage section (in this example, the second storage section 123). In this way, the information processing apparatus can suppress, on the basis of the frequency information stored in the storage section, that the malfunction is caused in the touch panel due to the radio wave irradiated from the external device.

Further, the information processing apparatus determines whether or not a predetermined program (in this example, the program 410) is stored in the external storage section if an external storage section (in this example, the external storage section 400) is connected, and changes the scan frequency if it is determined that the program is stored. In this way, the information processing apparatus can suppress, through the connection of the external storage section, that the malfunction is caused in the touch panel due to the radio wave irradiated from the external device. As a result, the information processing apparatus can easily change the scan frequency at a timing desired by the user.

Further, the information processing apparatus periodically changes the scan frequency to the frequency indicated by each of a plurality of frequency information different from each other stored in advance in a storage section (in this example, the second storage section 123) each time the external storage section is connected. In this way, the information processing apparatus can more certainly suppress that the malfunction is caused in the touch panel due to the radio wave irradiated from the external device in such a manner that the user repeatedly connects the external storage section.

Further, the information processing apparatus changes the scan frequency depending on a predetermined operation (in this example, the operation for pressing the frequency change button) serving as the received operation. In this way, the information processing apparatus can suppress, through the operation, that the malfunction is caused in the touch panel due to the radio wave irradiated from the external device. As a result, the information processing apparatus can easily change the scan frequency at a timing desired by the user.

Further, the information processing apparatus periodically changes the scan frequency to the frequency indicated by each of the plurality of frequency information different from each other stored in advance in the storage section each time the predetermined operation serving as the received operation is carried out. In this way, the information processing apparatus can more certainly suppress that the malfunction is caused in the touch panel due to the radio wave irradiated from the external device in such a manner that the user repeatedly carries out the operation.

Further, the information processing apparatus enables a control section for controlling the touch panel (in this example, the second control section 121) to change the scan frequency. In this way, the information processing apparatus can change the scan frequency without putting a load on a control section for controlling the information processing apparatus (in this example, the first control section 300).

Further, in the information processing apparatus, the frequency change control section is included in another device connected with the information processing apparatus, and the another device is detachable with respect to the information processing apparatus. In this way, in the information processing apparatus, the user can change the scan frequency from any location.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

What is claimed is:

1. An information processing apparatus, comprising:
an electrostatic capacity type touch panel; and
a frequency change controller configured to change a scan frequency of the touch panel.

2. The information processing apparatus according to claim 1, wherein
the frequency change controller changes the scan frequency to any of frequencies respectively indicated by a plurality of frequency information different from each other stored in a storage section.

3. The information processing apparatus according to claim 1, wherein
the frequency change controller determines whether or not a predetermined program is stored in an external storage section in a case in which the external storage section is connected to the information processing apparatus, and changes the scan frequency if it is determined that the predetermined program is stored.

4. The information processing apparatus according to claim 3, wherein
the frequency change controller periodically changes the scan frequency to a frequency indicated by each of the plurality of frequency information different from each other stored in advance in the storage section each time the external storage section is connected to the information processing apparatus.

5. The information processing apparatus according to claim 1, wherein
the frequency change controller changes the scan frequency depending on a predetermined operation serving as a received operation.

6. The information processing apparatus according to claim 5, wherein
the frequency change controller periodically changes the scan frequency to a frequency indicated by each of the plurality of frequency information different from each other stored in advance in a storage section each time the operation is carried out.

7. The information processing apparatus according to claim 1, wherein
the touch panel comprises a control section configured to control the touch panel; and
the frequency change controller enables the control section to change the scan frequency.

8. The information processing apparatus according to claim 1, wherein
the frequency change controller is comprised in another device connected with the information processing apparatus; and
the another device is detachable with respect to the information processing apparatus.

9. A frequency change method, including:
determining, by an information processing apparatus comprising an electrostatic capacity type touch panel, whether or not a predetermined condition is met; and
changing, by the information processing apparatus, a scan frequency of the touch panel depending on a determination result.

10. The frequency change method according to claim 9, further comprising:
changing, by the information processing apparatus, the scan frequency to any of frequencies respectively indicated by a plurality of frequency information different from each other stored.

11. The frequency change method according to claim 9, further comprising:
determining, by the information processing apparatus, whether or not a predetermined program is stored in an external storage section in a case in which an external storage section is connected to the information processing apparatus, and changing the scan frequency if it is determined that the predetermined program is stored.

12. The frequency change method according to claim 11, further comprising:
periodically changing, by the information processing apparatus, the scan frequency to a frequency indicated by each of the plurality of frequency information different from each other stored in advance in the storage section each time the external storage section is connected to the information processing apparatus.

13. The frequency change method according to claim 9, further comprising:
changing, by the information processing apparatus, the scan frequency depending on a predetermined operation serving as a received operation.

14. The frequency change method according to claim 13, further comprising:
periodically changing, by the information processing apparatus, the scan frequency to a frequency indicated by each of the plurality of frequency information different from each other stored in advance in a storage section each time the operation is carried out.

15. A non-transitory recording medium for storing a program comprising operations, the operations comprising:
determining, by an information processing apparatus comprising an electrostatic capacity type touch panel, whether or not a predetermined condition is met; and
changing, by the information processing apparatus, a scan frequency of the touch panel depending on a determination result.

16. The non-transitory recording medium according to claim 15, further comprising:
determining, by the information processing apparatus, whether or not a predetermined program is stored in an external storage section in a case in which an external storage section is connected to the information processing apparatus, and changing the scan frequency if it is determined that the predetermined program is stored.

17. The non-transitory recording medium according to claim 16, further comprising:
periodically changing, by the information processing apparatus, the scan frequency to a frequency indicated by each of the plurality of frequency information different from each other stored in advance in the storage section each time the external storage section is connected to the information processing apparatus.

18. The non-transitory recording medium according to claim 15, further comprising:
changing, by the information processing apparatus, the scan frequency depending on a predetermined operation serving as a received operation.

19. The non-transitory recording medium according to claim 18, further comprising:
periodically changing, by the information processing apparatus, the scan frequency to a frequency indicated by each of the plurality of frequency information different from each other stored in advance in a storage section each time the operation is carried out.

20. An information processing apparatus comprising the non-transitory recording medium according to claim 15.
